(19) United States
(12) Patent Application Publication
(10) Pub. No.: US 2007/0125470 A1
(43) Pub. Date: Jun. 7, 2007

(54) Inner tube apparatus and method of use

(76) Inventors: William M. VanCleave, Brookings, OR (US); Richard Pfremmer, Smith River, CA (US)

Correspondence Address: Galasso & Associates, LP, P.O. Box 26503, Austin, TX, 78755-0503, US

(21) Appl. No.: 11/507,848

(22) Filed: Aug. 22, 2006

Related U.S. Application Data
(60) Provisional application No. 60/742,332, filed on Dec. 5, 2005.

(51) Int. Cl. B60C 5/04

(52) U.S. Cl. 152/511

(57) ABSTRACT

An inner tube apparatus and method of use are provided. In one form, an inner tube apparatus includes a hermetically sealed annular compartment including an inner wall, an outer wall, a wall thickness, a diameter, a first sealed termination, and a second sealed termination. The annular compartment includes a threaded valve stem disposed on a surface of the compartment and a threaded valve stem cap, operable to provide a hermetic seal when coupled to the valve stem. The inner tube apparatus may be used to replace a motorcycle tire inner tube without necessitating the removal of the motorcycle from its wheel assembly by separating the sealed terminations and placing the apparatus on the motorcycle wheel. When filled with air, the sealed terminations abut, forming a strong, contiguous, annular hermetically sealed compartment.

### CROSS REFERENCE TO RELATED APPLICATIONS

This application claims priority to co-pending U.S. Provisional patent application having Ser. No. 60/742,332 filed Dec. 5, 2005 entitled “Retyre”, having a common applicant herewith.

### FIELD OF THE DISCLOSURE

The invention generally relates to inner tubes, and more particularly to an inner tube apparatus for use with a pneumatic tire and method of use.

### BACKGROUND

The United States of America has been accurately referred to as a nation on wheels, as its countryside, suburbs, and cities are crisscrossed with roads and highways. One motor vehicle that has seen a dramatic increase in popularity is the motorcycle. Not only is it a mode of transportation, but recreational motorcycle riding has become a popular pastime for riders of all ages and socioeconomic backgrounds. One downside to the increased popularity of motorcycle riding is its inherent dangers. One such danger is the danger of tire failure. Once a motorcycle tire fails, replacing it is not a simple matter or removing the tire and replacing it with a spare tire carried on the vehicle, as is the case with an automobile. The tube on a motorcycle cannot be replaced without removing the wheel, which is not a safe task to perform on the side of the road with passing traffic. The motorcycle needs to be taken to a shop, which costs for the tow bill, labor and parts, and greatly inconveniences the rider due to the time lost during the towing and repairing processes. What is needed is an inner tube replacement that may be transported in a compact manner that allows a user to replace a motorcycle inner tube without necessitating the removal of the wheel assembly.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a front perspective view of an inner tube apparatus for use with a pneumatic tire in accordance with one aspect of the present invention; and

FIG. 2 illustrates a cross section view of an inner tube apparatus for use with a pneumatic tire in accordance with one aspect of the invention

### DESCRIPTION

An inner tube apparatus for use with a pneumatic tire and method of use are provided. In one form, an inner tube apparatus for use with a pneumatic tire includes a hermetically sealed compartment with a first sealed termination and a second sealed termination. The inner tube apparatus further includes a threaded valve stem disposed on a surface of the hermetically sealed compartment and a threaded valve stem cap that forms a hermetic seal when coupled to the threaded valve stem. The hermetically sealed compartment includes an inner wall, an outer wall, and a cavity. The inner tube apparatus may be used with a variety of tires, including, but not limited to, tires of motorcycles and bicycles. The inner tube apparatus includes a load rating and a pounds per square inch (PSI) rating equal to or greater than a standard inner tube. The threaded valve stem may be used with a standard air compressor and a standard tire pump. The inner tube apparatus includes a circular cross section when the hermetically sealed compartment is filled with air. The inner tube apparatus may be folded flat for storage and portability when the air is removed from the hermetically sealed compartment. The inner tube apparatus allows the replacement of an inner tube without necessitating the removal of the wheel containing the tire, by virtue of the apparatus having two sealed terminations rather than having an unbroken ring, as does a standard inner tube. The user may simply cut the existing inner tube to remove it from the tire, insert the inner tube apparatus, push the valve stem through the valve stem aperture, and inflate the inner tube apparatus. The hermetically sealed compartment will expand when inflated, with the first sealed termination and second sealed terminations abutting, forming a contiguous circle.

According to another aspect of the invention, an inner tube apparatus for use with a pneumatic tire and method of use are provided. The inner tube apparatus for use with a pneumatic tire includes a hermetically sealed compartment including a first sealed termination and a second sealed termination, a threaded air valve stem disposed on a surface of the hermetically sealed compartment, and a threaded valve stem cap operable to hermetically seal the compartment when coupled to the threaded air valve stem. In one embodiment, the hermetically sealed compartment is primarily natural rubber. In another embodiment, the hermetically sealed compartment is primarily synthetic rubber. When the hermetically sealed compartment is filled with air, the apparatus takes on an annular shape. The first sealed termination and the second sealed termination abut when the hermetically sealed compartment is filled with air, creating a contiguous annular shape. In one embodiment, the first sealed termination binds with the second sealed termination when the hermetically sealed compartment is filled with air, creating an unbroken contiguous inflated ring. In one embodiment, the apparatus will accept and retain coloring.

According to a further aspect of the invention, an inner tube apparatus for use with a pneumatic tire and method of use are provided. The inner tube apparatus for use with a pneumatic tire includes a hermetically sealed compartment including an inner wall, an outer wall, a wall thickness, a diameter, a first sealed termination and a second sealed termination. The inner tube apparatus further includes a threaded air valve stem disposed on a surface of the hermetically sealed annular compartment, and a threaded valve stem cap which seals the hermetically sealed annular compartment when coupled to the threaded air valve stem. When fully inflated, the hermetically sealed compartment includes a circular cross section and includes an annular shape. The hermetically sealed annular compartment further comprises a diameter of at least twelve (12) inches and no more than thirty-six (36) inches and a wall thickness of at least one sixty-fourth ( 1/64) inch and no more than one (1) inch

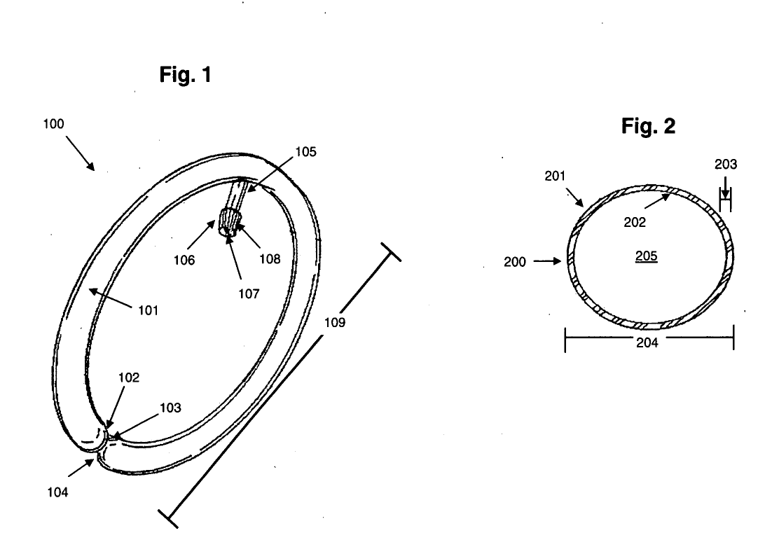

FIG. 1 illustrates a front perspective view of an inner tube apparatus for use with a pneumatic tire in accordance with one aspect of the present invention. A front perspective view of an inner tube apparatus for use with a pneumatic tire is illustrated generally at 100. Hermetically sealed compartment 101 includes first sealed termination 102 and second sealed termination 103. Gap 104 between first sealed termination 102 and second sealed termination 103 allows apparatus 100 to be installed as a replacement inner tube without needing to remove the wheel from the assembly, making the apparatus a perfect choice for use in replacing a ruptured motorcycle inner tube while traveling, saving the inconvenience and expense of being towed to a repair facility. Inner tube apparatus 100 includes valve stem 105 disposed on a surface of hermetically sealed compartment 101. Valve stem 105 includes an opening (not expressly shown) disposed on hermetically sealed compartment 101, usable for insertion of air into hermetically sealed compartment 101. Valve stem 105 further includes a threaded aperture (not expressly shown) on the opposite end of the valve aperture (not expressly shown) disposed on hermetically sealed compartment 101. This aperture may be coupled to a variety of devices for inflation of hermetically sealed compartment 101 including, but not limited to, air compressors, hand pumps, and canned air. Inner tube apparatus 100 further includes valve stem cap 106. Valve stem cap 106 includes circular top portion 107, a ridged conical side portion 108, tapering from a threaded aperture (not expressly shown) to circular top portion 107. Ridged conical side portion 108 serves to enhance the user's grip, easing placement or removal of valve stem cap 106 on valve stem 105. Valve stem cap 106 creates a hermetic seal when tightly coupled to the threaded aperture (not expressly shown) of valve stem 105. When hermetically sealed compartment 101 is filled with air, compartment 101 takes on an annular shape. First sealed termination 102 then abuts second sealed termination 103, reducing the size of gap 104 until no separation exists between first sealed termination 102 and second sealed termination 103. Further, as hermetically sealed compartment 101 becomes inflated, inner tube apparatus 100 forms a contiguous annular shape with first sealed termination 102 abutting second sealed termination 103, giving inner tube apparatus a strong, contiguous, annular shape with diameter 109. In one embodiment, first sealed termination 102 binds to second sealed termination 103 when hermetically sealed compartment 101 is fully inflated. Binding may be provided in a variety of forms including, but not limited to, glue, reusable adhesive, magnets, a plurality of interlocking apertures and protrusions, and a hook and loop material. Diameter 109 may be provided in various diameters and in one embodiment is twelve (12) inches. In another embodiment, diameter 109 is twenty-four (24) inches.

Inner tube apparatus 100 may be provided in a variety of materials and in one embodiment includes a natural rubber material. In another embodiment, inner tube apparatus 100 includes a synthetic rubber material. Hermetically sealed compartment 101 is capable of accepting and retaining coloring. Inner tube apparatus 100 further includes a durable material of a pounds per square inch (PSI) rating and a load rating comparable or superior to a standard motorcycle or bicycle inner tube. In one embodiment, inner tube apparatus may be used with a motorcycle tire. In another embodiment, inner tube apparatus may be used with a bicycle tire.

During use, a user experiencing a flat tire on a motorcycle pulls over to the side of the road while maintaining control of the motorcycle. A user may remove inner tube apparatus 100 from a compact folded position stored in a variety of places including, but not limited to, a compartment on the motorcycle, in a storage compartment, or a pocket on a user's garment. A user may remove the old inner tube from the fire by cutting the old fire and removing it from the rim, without removing the wheel from the wheel assembly. Inner tube apparatus 100 would be inserted around the rim of the tire, with gap 104 allowing apparatus 100 to be inserted with the wheel assembly still on the motorcycle. A user then may insert valve stem 105 through the valve stem aperture in the motorcycle fire. Deflated inner tube apparatus 100 would then encircle the fire rim with first sealed termination 102 abutting second sealed termination 103. A user would remove valve stem cap 106 by grasping ridged conical side portion 108 and twisting valve stem cap 106. A user would then inflate inner tube apparatus 100 by placing an inflator on the open end of valve stem 105. The inflator may be provided in various embodiments including, but not limited to, an air compressor, a hand pump, and canned air. As air fills hermetically sealed compartment 101, inner tube apparatus 100 takes on an annular shape as first sealed termination 102 abuts second sealed termination 103, eliminating gap 104 and providing a strong contiguous annular hermetically sealed compartment 101. The user may then mount the motorcycle and ride to the nearest repair station.

FIG. 2 illustrates a cross section perspective view of an inner tube apparatus for use with a pneumatic tire in accordance with one aspect of the present invention. A cross section of an inner tube apparatus for use with a pneumatic tire is illustrated generally at 200. Inner tube apparatus 200 includes outer wall 201, inner wall 202, wall thickness 203, cross section diameter 204, and inner cavity 205. Wall thickness 203 may be provided in various thicknesses and in one embodiment is one sixty-fourth ( 1/64) of an inch. In another embodiment, wall thickness 203 is one (1) inch. Further, cross section diameter 204 may be provided in various diameters and in one embodiment is one half (½) of an inch. In another embodiment, cross section diameter 204 is twenty (20) inches.

During use, a user inflates inner tube apparatus 200. As inner tube apparatus 200 inflates, inner cavity 205 becomes filled with air, pushing outer wall 201 and inner wall 202 outward, causing outer wall 201 and inner wall 202 to expand concentrically. As inner cavity 205 fills with air, inner cavity 205 generally takes on a circular shape, forming a circular cross section generally illustrated at 200. Inner wall 201 and outer wall 202 may be formed of a variety of materials, including but not limited to natural rubber and synthetic rubber.

Note that although an embodiment of the invention has been shown and described in detail herein, along with certain variants thereof, many other varied embodiments that incorporate the teachings of the invention may be easily constructed by those skilled in the art. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the invention is not intended to be limited to the specific form set forth herein, but on the contrary, it is intended to cover such alternatives, modifications, and equivalents, as can be reasonably included within the spirit and scope of the invention.

What is claimed is:

1. An inner tube apparatus for use with a pneumatic fire, comprising:
a hermetically sealed compartment including a first sealed termination and a second sealed termination;
a threaded valve stem disposed on a surface of the hermetically sealed compartment; and
a threaded valve stem cap.

2. The apparatus of claim 1 wherein the hermetically sealed compartment includes an inner wall, an outer wall, and a cavity.

3. The apparatus of claim 1 wherein the apparatus is operable for use in a standard motorcycle tire.

4. The apparatus of claim 1 wherein the apparatus is operable for use in a standard bicycle tire.

5. The apparatus of claim 1 wherein the apparatus comprises a load rating and a pounds per square inch (PSI) rating equal to or greater than a standard inner tube.

6. The apparatus of claim 1 wherein the threaded valve stem comprises a standard tire valve stem operable to be used with a standard air compressor and a standard tire pump.

7. The apparatus of claim 1 wherein the threaded valve stem cap couples to the threaded valve stem, operable to form a hermetic seal.

8. The apparatus of claim 1 wherein the hermetically sealed compartment comprises a circular cross section when the hermetically sealed compartment is filled with air.

9. The apparatus of claim 11 wherein the apparatus may be folded into a compacted position when substantially all of the air has been removed from the hermetically sealed compartment.

10. The apparatus of claim 1 wherein the apparatus is operable to replace an inner tube in a tire without removal of the wheel assembly.

11. An inner tube apparatus for use with a pneumatic tire, comprising:
a hermetically sealed compartment including a first sealed termination and a second sealed termination;
a threaded air valve stem disposed on a surface of the hermetically sealed compartment;
a threaded valve stem cap operable to hermetically seal the compartment when coupled to the threaded air valve stem.

12. The apparatus of claim 11 wherein the apparatus primarily comprises natural rubber.

13. The apparatus of claim 11 wherein the apparatus primarily comprises synthetic rubber.

14. The apparatus of claim 11 wherein the apparatus comprises an annular shape when the hermetically sealed compartment is inflated.

15. The apparatus of claim 11 wherein the first sealed termination and second sealed termination abut when the hermetically sealed compartment is inflated, further comprising a contiguous annular compartment.

16. The apparatus of claim 11 wherein the first sealed termination binds to the second sealed termination when the hermetically sealed compartment is filled with air, eliminating movement of the first and second sealed terminations.

17. The apparatus of claim 11 wherein the hermetically sealed compartment outer wall comprises a material capable of accepting and retaining coloring.

18. An inner tube apparatus for use with a pneumatic tire, comprising:
a hermetically sealed annular compartment including an inner wall, an outer wall, a wall thickness, a diameter, a first sealed termination, and a second sealed termination;
a threaded air valve stem disposed on a surface of the hermetically sealed annular compartment;
a threaded valve stem cap operable to hermetically seal the annular compartment when coupled to the threaded air valve stem.

19. The apparatus of claim 18 wherein the hermetically sealed annular compartment further comprises a circular cross section with a cross section diameter when the hermetically sealed compartment is inflated.

20. The apparatus of claim 18, wherein the hermetically sealed annular compartment further comprises a diameter of at least twelve (12) inches and no more than thirty-six (36) inches and a wall thickness of at least one sixty-fourth ( 1/64) inch and no more than one (1) inch.
